(19) United States
(12) Patent Application Publication
(10) Pub. No.: US 2023/0213623 A1
(43) Pub. Date: Jul. 6, 2023

(54) SYSTEMS AND METHODS FOR SCANNING A REGION OF INTEREST USING A LIGHT DETECTION AND RANGING SCANNER

(71) Applicant: Innovusion, Inc., Sunnyvale, CA (US)

(72) Inventors: Yufeng Li, Milpitas, CA (US); Gang Zhou, San Jose, CA (US); Peng Wan, Fremont, CA (US); Hoasen Wang, Sunnyvale, CA (US); Jian Wen, Fremont, CA (US); Yimin Li, Cupertino, CA (US); Zheng Yang, Los Altos, CA (US)

(73) Assignee: Innovusion, Inc., Sunnyvale, CA (US)

(21) Appl. No.: 18/092,866

(22) Filed: Jan. 3, 2023

Related U.S. Application Data
(60) Provisional application No. 63/296,142, filed on Jan. 3, 2022.

(51) Int. Cl. G01S 7/481; G01S 17/931; B60R 11/00

(52) U.S. Cl. CPC G01S 7/4817; B60R 11/00; G01S 17/931; B60R 2011/004

(57) ABSTRACT

A light detection and ranging (LiDAR) system for scanning and reconfiguring regions-of-interest (ROIs) is provided. The system comprises a LiDAR scanner configured to scan a current set of ROIs within a field-of-view (FOV), and a LiDAR perception sub-system coupled to the LiDAR scanner. The LIDAR perception sub-system includes instructions for: obtaining sensor data provided at least by the LiDAR scanner; deriving one or more current perceptions based on the sensor data; obtaining one or more predefined perception policies; determining one or more policy-based ROI candidates; determining whether an ROI reconfiguration request is provided, based on a vehicle perception decision; determining one or more request-based ROI candidates based on the ROI reconfiguration request; and determining a next set of ROIs for the LiDAR scanner to scan based on the current set of ROIs, and one or both of the one or more policy-based ROI candidates and the one or more request-based ROI candidates.

### CROSS-REFERENCE TO RELATED APPLICATIONS

This application claims priority to U.S. Provisional Pat. Application Serial No. 63/296,142, filed Jan. 3, 2022, entitled “SYSTEMS AND METHODS FOR SCANNING A REGION OF INTEREST USING A LIGHT DETECTION AND RANGING SCANNER,” the content of which is hereby incorporated by reference in its entirety for all purposes.

### FIELD OF THE TECHNOLOGY

This disclosure relates generally to optical scanning and, more particularly, to a LiDAR scanning system having reconfigurable regions-of-interest (ROIs).

### BACKGROUND

Light detection and ranging (LiDAR) systems use light pulses to create an image or point cloud of the external environment. Some typical LiDAR systems include a light source, a light transmitter, a light steering system, and a light detector. The light source generates a light beam that is directed by the light steering system in particular directions when being transmitted from the LiDAR system. When a transmitted light beam is scattered by an object, a portion of the scattered light returns to the LiDAR system as a return light pulse. The light detector detects the return light pulse. Using the difference between the time that the return light pulse is detected and the time that a corresponding light pulse in the light beam is transmitted, the LiDAR system can determine the distance to the object using the speed of light. The light steering system can direct light beams along different paths to allow the LiDAR system to scan the surrounding environment and produce images or point clouds. LiDAR systems can also use techniques other than time-of-flight and scanning to measure the surrounding environment.

### SUMMARY

Embodiments described herein refer to LiDAR systems and methods that can scan and reconfigure regions-of-interest (ROIs) in a field-of-view (FOV). A LiDAR system scans the external environment to generate image or point cloud data in an FOV. Sometimes, configuring one or more ROIs in an FOV is desired or requested by the LiDAR system itself or a vehicle computer, so that the ROI regions can be scanned with higher resolutions. ROI scanning is important for the vehicle to respond to certain driving conditions, find objects on the road, and identify objects with more accuracy, etc. In a dynamic driving environment, ROIs may need to be reconfigured when, for example, driving conditions have changed or when objects are moving.

A LiDAR system may have limited capacities so that only a limited number or size of ROIs can be scanned in a given frame. Moreover, different objects on the road may have different scan priorities. It is therefore important for a vehicle driving system to be able to determine, based on various factors and considerations, the order of potential ROIs to be scanned, and pick the highest priority (e.g., most “urgent”) ROIs that needed to be scanned next. Techniques discussed herein enable a LiDAR system or a vehicle computer to scan and reconfigure ROIs in real time based on priority.

In one embodiment, a LiDAR system for scanning and reconfiguring regions-of-interest (ROIs) is provided. The system includes a LiDAR scanner configured to scan a current set of regions-of-interest (ROIs) within a field-of-view (FOV), and a LiDAR perception sub-system coupled to the LiDAR scanner. The LIDAR perception sub-system includes one or more processors, a memory device, and processor-executable instructions stored in the memory device, the processor-executable instructions comprising instructions for the following: obtaining sensor data provided at least by the LiDAR scanner; deriving one or more current perceptions based on the sensor data; obtaining one or more predefined perception policies; determining one or more policy-based ROI candidates based on the one or more predefined perception policies that correlate with the one or more current perceptions; determining whether an ROI reconfiguration request is provided, where the ROI reconfiguration request is provided based on a vehicle perception decision; in accordance with an ROI reconfiguration request being provided, determining one or more request-based ROI candidates based on the ROI reconfiguration request; and determining a next set of ROIs for the LiDAR scanner to scan based on the current set of ROIs, and one or both of the one or more policy-based ROI candidates and the one or more request-based ROI candidates.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more exemplary LiDAR systems disposed or included in a motor vehicle.

FIG. 2 is a block diagram illustrating interactions between an exemplary LiDAR system and multiple other systems including a vehicle perception and planning system.

FIG. 3 is a block diagram illustrating an exemplary LiDAR system.

FIG. 4 is a block diagram illustrating an exemplary fiber-based laser source.

FIGS. 5A-5C illustrate an exemplary LiDAR system using pulse signals to measure distances to objects disposed in a field-of-view (FOV).

FIG. 6 is a block diagram illustrating an exemplary apparatus used to implement systems, apparatus, and methods in various embodiments.

FIG. 7A illustrates a field-of-view (FOV) of a LiDAR system with multiple regions-of-interest (ROIs) according to one embodiment.

FIG. 7B illustrates a scanning pattern with one ROI in normal mode.

FIG. 7C illustrates a scanning pattern with two ROIs in normal mode.

FIG. 7D illustrates a scanning pattern without ROI in calibration mode.

FIG. 8 illustrates a flow diagram of a method for determining the next set of ROIs according to one embodiment.

FIG. 9 illustrates a flow diagram of a method of using an ROI scan list for determining the next set of ROIs according to one embodiment.

### DETAILED DESCRIPTION

To provide a more thorough understanding of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the termIs “coupled to” and “coupled with” are also used to mean “communicatively coupled with”, possibly via one or more intermediary devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

Throughout the following disclosure, numerous references may be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, PLD, DSP, x86, ARM, RISC-V, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable medium storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, etc.). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

Embodiments of the present invention are described below. In various embodiments of the present invention, one embodiment of a LiDAR system includes a LiDAR scanner configured to scan a current set of regions-of-interest (ROIs) within a field-of-view (FOV), and a LiDAR perception sub-system coupled to the LiDAR scanner. The LIDAR perception subsystem includes one or more processors, a memory device, and processor-executable instructions stored in the memory device, the processor-executable instructions comprising instructions for the following: obtaining sensor data provided at least by the LiDAR scanner; deriving one or more current perceptions based on the sensor data; obtaining one or more predefined perception policies; determining one or more policy-based ROI candidates based on the one or more predefined perception policies that correlate with the one or more current perceptions; determining whether an ROI reconfiguration request is provided, where the ROI reconfiguration request is provided based on a vehicle perception decision; in accordance with an ROI reconfiguration request being provided, determining one or more request-based ROI candidates based on the ROI reconfiguration request; and determining a next set of ROIs for the LiDAR scanner to scan based on the current set of ROIs, and one or both of the one or more policy-based ROI candidates and the one or more request-based ROI candidates.

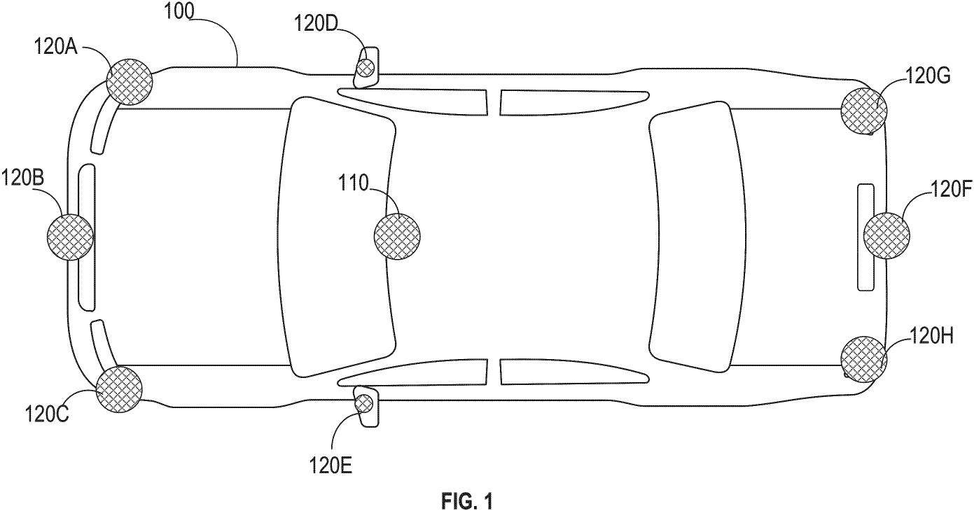

FIG. 1 illustrates one or more exemplary LiDAR systems 110 disposed or included in a motor vehicle 100. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver’s intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver’s intervention but can also detect its own limits and ask the driver to take over when necessary. A driverless vehicle can operate on its own without any driver intervention.

In typical configurations, motor vehicle 100 comprises one or more LiDAR systems 110 and 120A-F. Each of LiDAR systems 110 and 120A-F can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is often an essential sensor of a vehicle that is at least partially automated. In one embodiment, as shown in FIG. 1, motor vehicle 100 may include a single LiDAR system 110 (e.g., without LiDAR systems 120A-F) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-F. As shown in FIG. 1, in one embodiment, multiple LiDAR systems 110 and/or 120A-F are attached to vehicle 100 at different locations of the vehicle. For example, LiDAR system 120A is attached to vehicle 100 at the front right corner; LiDAR system 120B is attached to vehicle 100 at the front center; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; and/or LiDAR system 120F is attached to vehicle 100 at the back center. In some embodiments, LiDAR systems 110 and 120A-F are independent LiDAR systems having their own respective laser sources, control electronics, transmitters, receivers, and/or steering mechanisms. In other embodiments, some of LiDAR systems 110 and 120A-F can share one or more components, thereby forming a distributed sensor system. In one example, optical fibers are used to deliver laser light from a centralized laser source to all LiDAR systems. It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

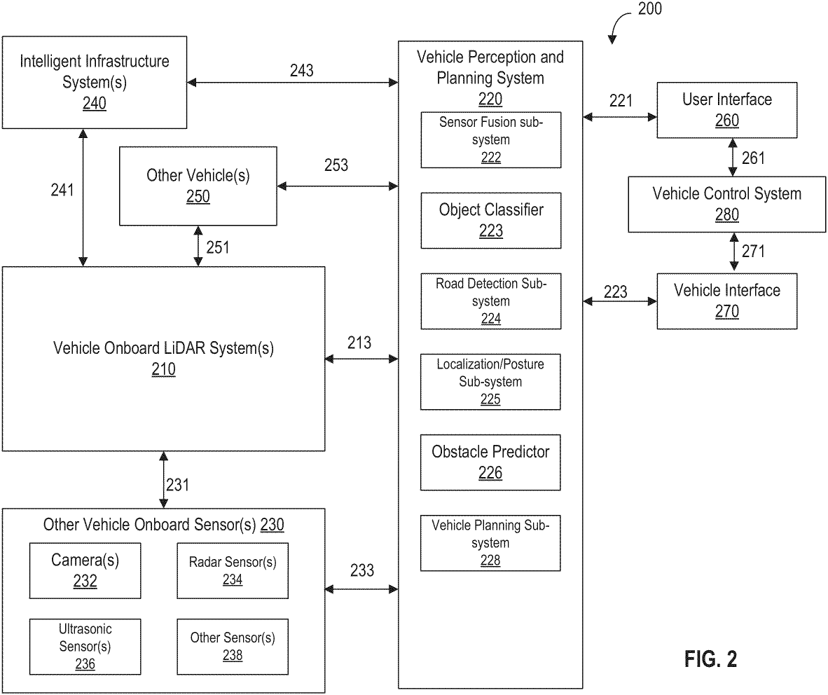

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-40 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 100-150 meters from the LiDAR sensor. Medium-range LiDAR sensors can be used for, e.g., monitoring road intersections, assistance for merging onto or leaving a freeway, or the like. A long-range LiDAR sensor measures objects located up to about 150-300 meters. Long-range LiDAR sensors are typically used when a vehicle is travelling at high speed (e.g., on a freeway), such that the vehicle’s control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are used to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera produces monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data.

Other vehicle onboard sensos(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object’s position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations.

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, check blind spot, identify parking spots, provide lane changing assistance into traffic, or the like. Sensor data generated by ultrasonic sensor(s) 236 can also be provided to vehicle perception and planning system 220 via communication path 233 for further processing and controlling the vehicle operations.

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud service for processing and then the processing results can be transmitted back to the vehicle perception and planning system 220).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is a behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210, thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffics in the opposite direction. In such a situation, sensors of intelligent infrastructure system(s) 240 can provide useful, and sometimes vital, data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle’s headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection subsystem 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle’s posture. For example, using sensor data from LiDAR system(s) 210, camera(s) 232, and/or GPS data, localization and vehicle posture sub-system 225 can determine an accurate position of the vehicle on the road and the vehicle’s six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle’s location. For instance, using the HD maps, localization and vehicle posture sub-system 225 can determine precisely the vehicle’s current position (e.g., which lane of the road the vehicle is currently in, how close it is to a curb or a sidewalk) and predict vehicle’s future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle’s trajectory intersects with the vehicle’s current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include a route planner, a driving behaviors planner, and a motion planner. The route planner can plan the route of a vehicle based on the vehicle’s current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle’s steering mechanism, throttle, brake, etc., to operate the vehicle according to the planned route and movement. Vehicle perception and planning system 220 may further comprise a user interface 260, which provides a user (e.g., a driver) access to vehicle control system 280 to, for example, override or take over control of the vehicle when necessary. User interface 260 can communicate with vehicle perception and planning system 220, for example, to obtain and display raw or fused sensor data, identified objects, vehicle’s location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

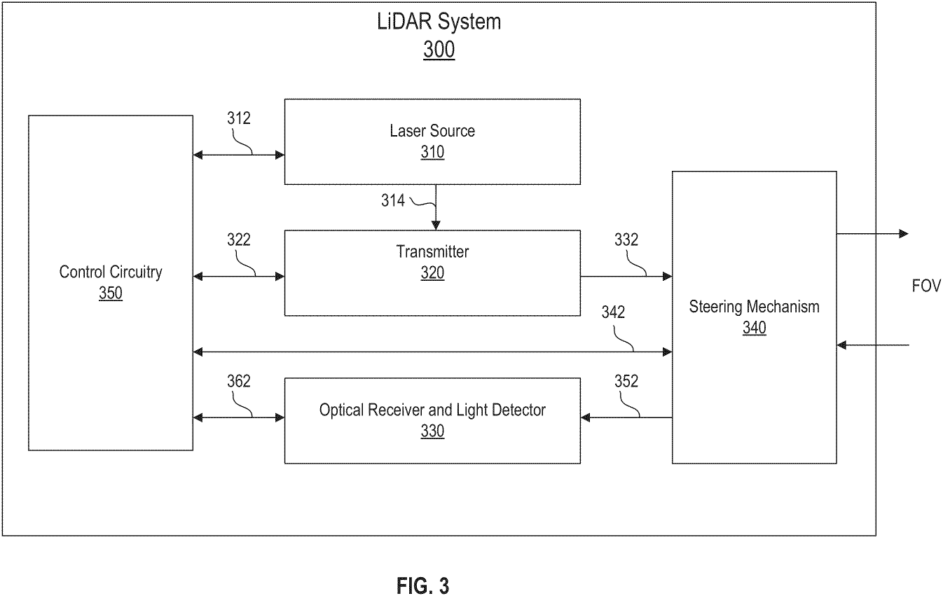

FIG. 3 is a block diagram illustrating an exemplary LiDAR system 300. LiDAR system 300 can be used to implement LiDAR system 110, 120A-F, and/or 210 shown in FIGS. 1 and 2. In one embodiment, LiDAR system 300 comprises a laser source 310, a transmitter 320, an optical receiver and light detector 330, a steering system 340, and a control circuitry 350. These components are coupled together using communications paths 312, 314, 322, 332, 343, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between laser source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Laser source 310 outputs laser light for illuminating objects in a field of view (FOV). Laser source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, laser source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, laser source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals.

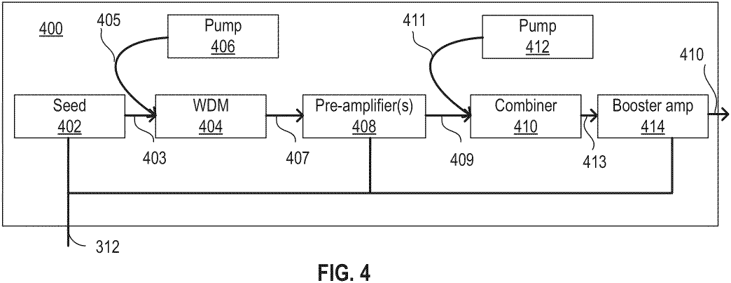

FIG. 4 is a block diagram illustrating an exemplary fiber-based laser source 400 having a seed laser and one or more pumps (e.g., laser diodes) for pumping desired output power. Fiber-based laser source 400 is an example of laser source 310 depicted in FIG. 3. In some embodiments, fiber-based laser source 400 comprises a seed laser 402 to generate initial light pulses of one or more wavelengths (e.g., 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 20-30 dB gain). In some embodiments, pre-amplifier(s) 408 are low noise amplifiers. Pre-amplifier(s) 408 output to a combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides pulses to a booster amplifier 414, which produces output light pulses via optical fiber 410. The booster amplifier 414 provides further amplification of the optical signals. The outputted light pulses can then be transmitted to transmitter 320 and/or steering mechanism 340 (shown in FIG. 3). It is understood that FIG. 4 illustrates one exemplary configuration of fiber-based laser source 400. Laser source 400 can have many other configurations using different combinations of one or more components shown in FIG. 4 and/or other components not shown in FIG. 4 (e.g., other components such as power supplies, lens, filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of laser source 310 comprise, for example, about 850 nm, about 905 nm, about 940 nm, about 1064 nm, and about 1550 nm. The upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from laser source 310 can be characterized by its peak power, average power, and the pulse energy. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. The PRR typically corresponds to the maximum range that a LiDAR system can measure. Laser source 310 can be configured to produce pulses at high PRR to meet the desired number of data points in a point cloud generated by the LiDAR system. Laser source 310 can also be configured to produce pulses at medium or low PRR to meet the desired maximum detection distance. Wall plug efficiency (WPE) is another factor to evaluate the total power consumption, which may be a key indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring laser source 310 and/or designing laser delivery systems for vehicle-mounted LiDAR applications.

It is understood that the above descriptions provide non-limiting examples of a laser source 310. Laser source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Laser source 310 provides laser light (e.g., in the form of a laser beam) to transmitter 320. The laser light provided by laser source 310 can be amplified laser light with a predetermined or controlled wavelength, pulse repetition rate, and/or power level. Transmitter 320 receives the laser light from laser source 310 and transmits the laser light to steering mechanism 340 with low divergence. In some embodiments, transmitter 320 can include, for example, optical components (e.g., lens, fibers, mirrors, etc.) for transmitting laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by laser source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, laser source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. Steering mechanism 340 will be described in more detail below. The laser light scanned to an FOV may be scattered or reflected by an object in the FOV. At least a portion of the scattered or reflected light returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focus, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One exemplary method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector’s capability of maintaining linear relationship between input optical signal power and the detector’s output. A detector having good linearity can maintain a linear relationship over a large dynamic input optical signal range.

To achieve desired detector characteristics, configurations or customizations can be made to the light detector’s structure and/or the detector’s material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, a APD (avalanche photodiode) based structure, a PMT (photomultiplier tube) based structure, a SiPM (Silicon photomultiplier) based structure, a SPAD (single-photon avalanche diode) base structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector’s internal gain. Common types of noise include signal shot noise, dark current shot noise, thermal noise, and amplifier noise (TIA). In some embodiments, optical receiver and light detector 330 may include a pre-amplifier that is a low noise amplifier (LNA). In some embodiments, the pre-amplifier may also include a TIA-transimpedance amplifier, which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implement signal processing techniques (e.g., filtering, noise reduction, amplification, or the like). For example, in addition to or instead of using direct detection of return signals (e.g., by using TOF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism or a scanning mechanism. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an exemplary non-scanning LiDAR system).

Steering mechanism 340 can be used with the transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or two devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s) for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lens) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling laser source 310 to obtain desired laser pulse timing, repetition rate, and power; controlling steering mechanism 340 (e.g., controlling the speed, direction, and/or other parameters) to scan the FOV and maintain pixel registration/alignment; controlling optical receiver and light detector 330 (e.g., controlling the sensitivity, noise reduction, filtering, and/or other parameters) such that it is an optimal state; and monitoring overall system health/status for functional safety.

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; and/or determines any other type of data relevant to LiDAR system 300.

LiDAR system 300 can be disposed in a vehicle, which may operate in many different environments including hot or cold weather, rough road conditions that may cause intense vibration, high or low humidifies, dusty areas, etc. Therefore, in some embodiments, optical and/or electronic components of LiDAR system 300 (e.g., optics in transmitter 320, optical receiver and light detector 330, and steering mechanism 340) are disposed or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one exemplary LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

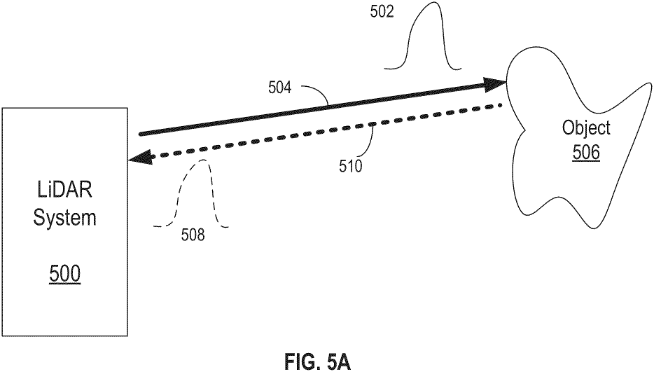

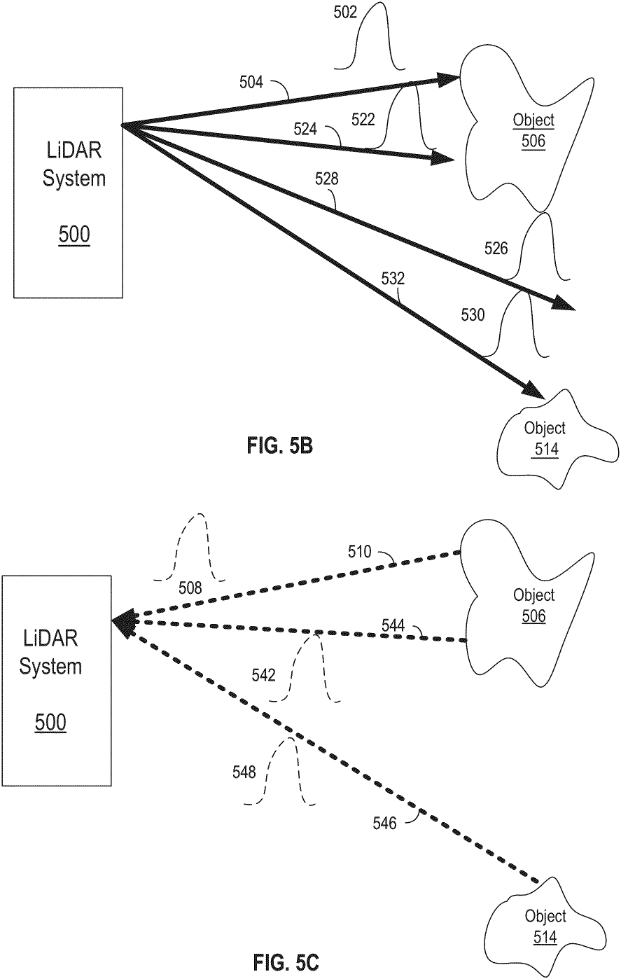

As described above, some LiDAR systems use the time-of-flight (TOF) of light signals (e.g., light pulses) to determine the distance to objects in a light path. For example, with reference to FIG. 5A, an exemplary LiDAR system 500 includes a laser light source (e.g., a fiber laser), a steering system (e.g., a system of one or more moving mirrors), and a light detector (e.g., a photon detector with one or more optics). LiDAR system 500 can be implemented using, for example, LiDAR system 300 described above. LiDAR system 500 transmits a light pulse 502 along light path 504 as determined by the steering system of LiDAR system 500. In the depicted example, light pulse 502, which is generated by the laser light source, is a short pulse of laser light. Further, the signal steering system of the LiDAR system 500 is a pulsed-signal steering system. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to generate a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are generated by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then it may be determined that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source with a higher pulse repetition rate (PRR) is needed. On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an exemplary LiDAR system that can transmit laser pulses with a repetition rate between 500 kHz and 1 MHz. Based on the time it takes for a pulse to return to the LiDAR system and to avoid mix-up of return pulses from consecutive pulses in a conventional LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

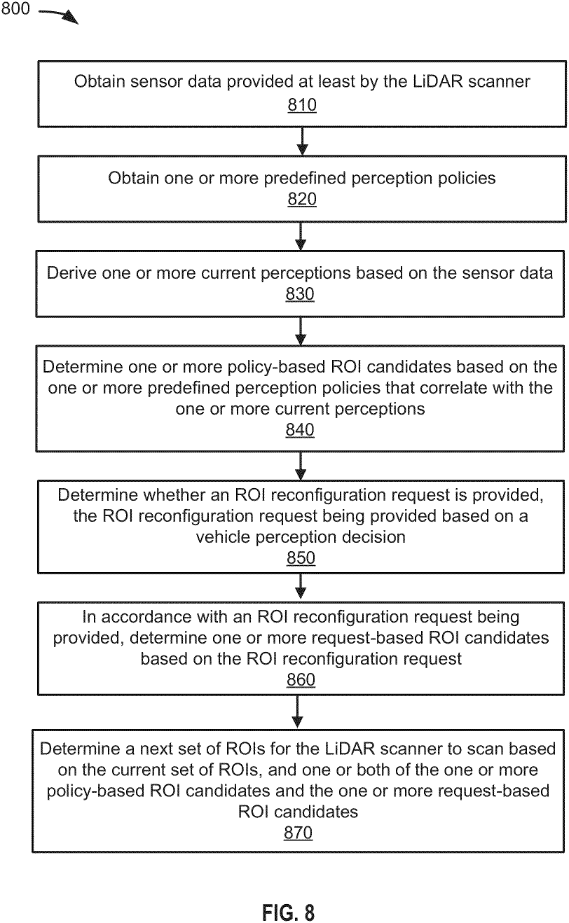

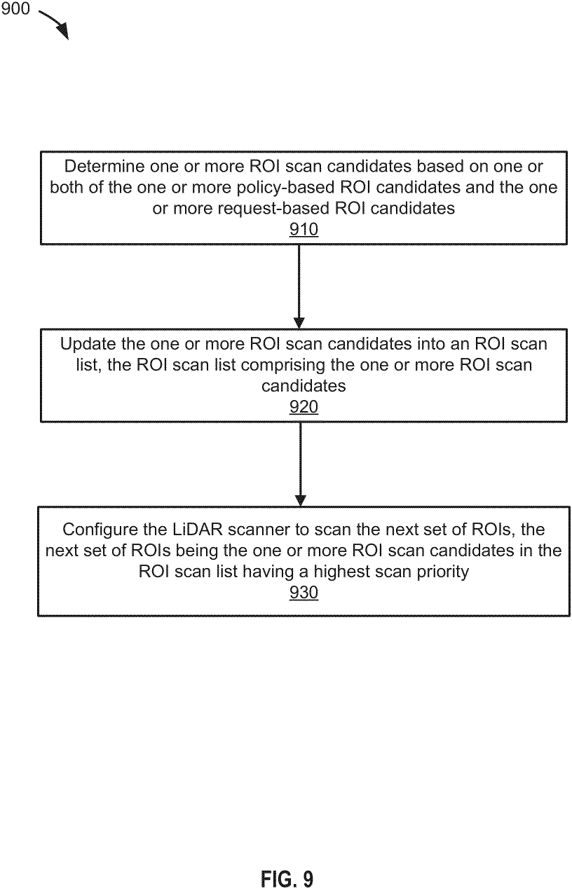

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of FIGS. 8 and 9, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

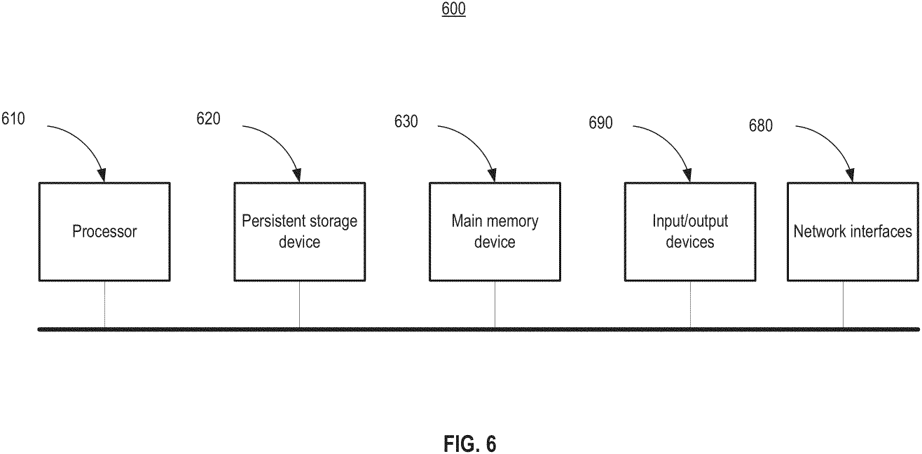

A high-level block diagram of an exemplary apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of FIGS. 8 and 9 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps of FIGS. 8 and 9. Accordingly, by executing the computer program instructions, the processor 610 executes an algorithm defined by the methods of FIGS. 8 and 9. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

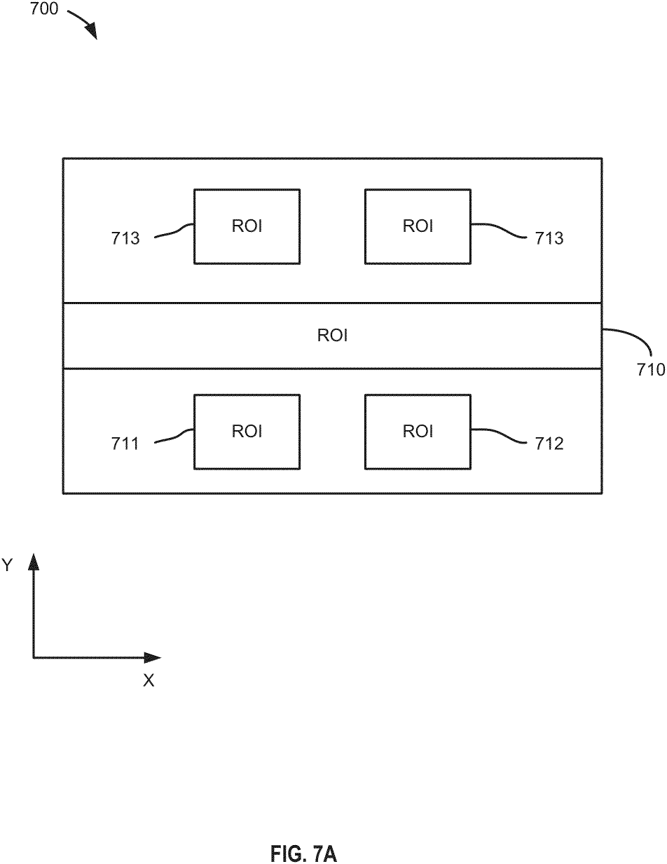

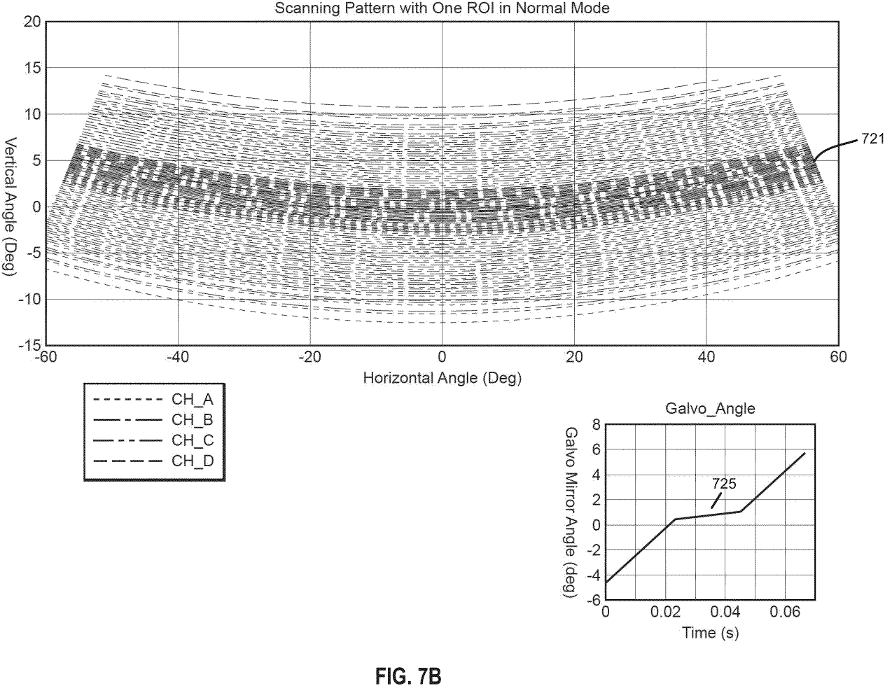

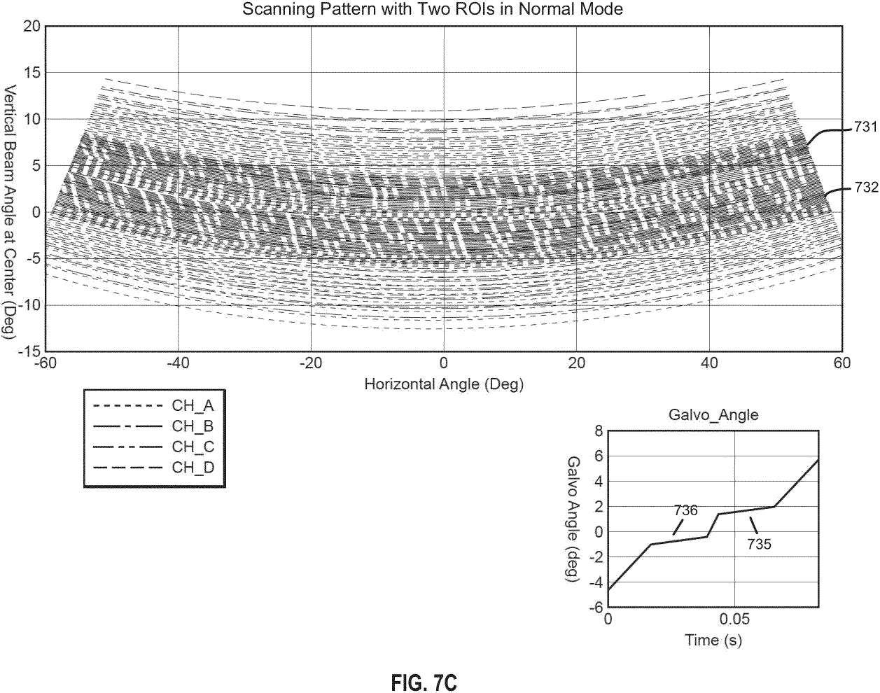

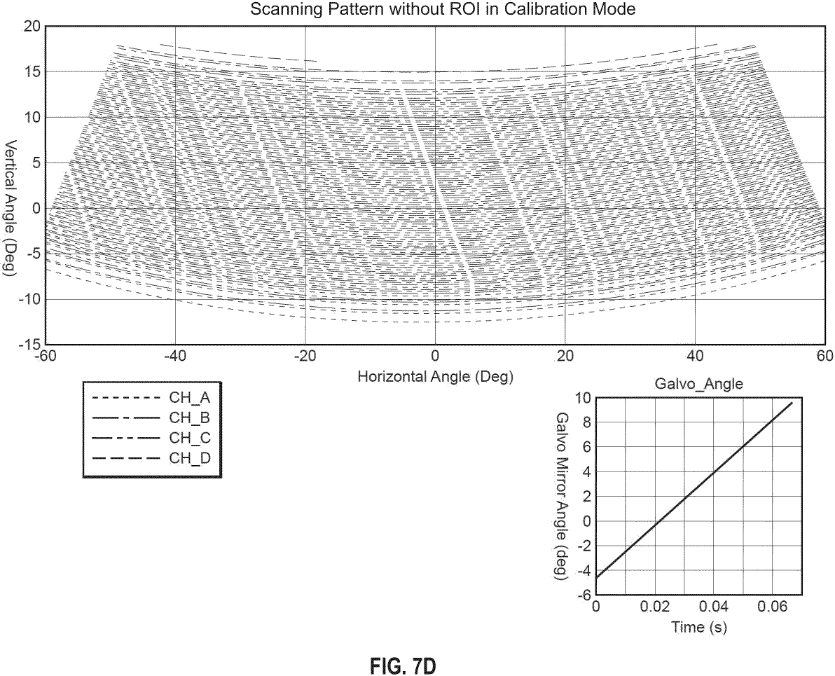

FIG. 7A illustrates a field-of-view (FOV) 700 of a LiDAR system with multiple regions-of-interest (ROIs) according to one embodiment. As shown, FOV 700 includes a two-dimensional space represented by X and Y dimensions (e.g., horizontal and vertical dimensions). Although the LiDAR system can collect data points from the entirety of FOV 700, certain regions of interest (ROI) may have higher resolution than non-ROI regions within FOV 700. Non-ROI regions are the one or more regions that occupy all space within FOV 700 that are not ROI.

Five different ROIs 710-714 are shown to illustrate different regions within FOV 700 that may require additional data points than other regions within FOV 700. For example, ROI 710 occupies an entire band of a fixed y-axis height across the x-axis of FOV 700. ROIs 711 and 712 show localized ROIs below ROI 710, and ROIs 713 and 714 show localized ROIs above ROI 710. It should be understood that any number of ROIs may exist and that the ROIs can occupy any portion of FOV 700.

In addition, some ROIs may have priority over other ROIs. Embodiments of the LiDAR system in this disclosure can be configured to scan any configurations of ROIs having any priorities. Moreover, embodiments discussed herein enable additional data points to be collected in the ROIs in a manner that does not disrupt the operation of the LiDAR system. For example, a LiDAR scanning system may scan the entirety of FOV 700 each scan cycle, while controlling one or more parameters to obtain additional data points from (or increase resolution of) the ROIs 711-714.

Increased resolution in the vertical direction may be achieved by increasing vertical angle resolution of the ROI region. Vertical angle resolution refers to spacing between adjacent rows of data points in the FOV. An increase in vertical angular resolution corresponds to denser spacing between adjacent rows, and such an increase can be achieved by decreasing the delta of the vertical angles between adjacent vertical angles. The delta between adjacent vertical angles can be decreased by slowing down the movement of mirrors, and in some examples, the movement of an oscillating mirror. As the mirror movement speed slows down, the change in the vertical angle delta decreases, resulting in higher resolution in the vertical direction.

FIG. 7B illustrates a scanning pattern with one ROI in normal mode. Similar to ROI 710, ROI 721 is an ROI that occupies an entire horizontal band with fixed vertical height across the horizontal direction of the FOV. FIG. 7B also shows the corresponding angular speed of the movement of a galvanometer mirror. As depicted by the figure, a decrease (reference 725) in angular speed of the galvanometer mirror results in a higher resolution in the vertical direction (ROI 721).

FIG. 7C illustrates a scanning pattern with two ROIs in normal mode. ROIs 731 and 732 are two ROIs, each occupies an entire horizontal band with fixed vertical height across the horizontal direction of the FOV. FIG. 7C also shows the corresponding angular speed of the galvanometer mirror. As depicted by the figure, a two-time decrease (references 735, 736) in angular speed of the galvanometer mirror results in higher resolutions in the vertical direction (ROIs 731 and 732).

FIG. 7D illustrates a scanning pattern without ROI in calibration mode. The angular speed of the galvanometer mirror is not decreased, resulting in no ROI in the entire FOV.

Increased resolution in the horizontal direction may be achieved by decreasing laser pulse intervals. The plurality of data points obtained within any row of FOV may depend on a horizontal angle within the horizontal range of the FOV. In some examples, the horizontal range may be controlled by a polygon mirror, and the horizontal angle resolution may be controlled by a time interval of successive laser pulses. The time interval is sometimes related to the pulse repetition rate. A smaller time interval can result in increased horizontal angular resolution, and a larger time interval can result in decreased horizontal angular resolution.

The number of ROIs, the position, size, shape, and resolution of each ROI are collectively referred to as the configuration of ROIs, or ROI configuration. It is understood that ROI configuration may include other characteristics of an ROI. The ROI configuration in an FOV may be limited by the capacity of the LiDAR system. For example, a particular LiDAR system may only be able to scan a maximum number of points, for example, one million points, in a given frame to form a point cloud. Increasing the horizontal and/or vertical angular resolutions of an ROI entails increasing the number of points in the ROI. Since the total number of points in any given frame is limited, the configuration of ROIs may be limited by the capacity of the LiDAR system.

However, the configuration of ROIs may be adjusted to accommodate the capacity of the LiDAR system. For example, if having one large ROI in a frame would exceed or significantly impact the LiDAR system’s capacity, several smaller ROIs may be implemented instead, so long as the total number of points of the entire FOV does not exceed the maximum capacity. For another example, if having multiple ROIs in a frame would exceed or significantly impact the LiDAR system’s capacity, the resolution of one or several of the ROIs may be reduced, while keeping the size of each ROI, so long as the total number of points of the entire FOV does not exceed the maximum capacity.

The configuration of ROIs of each frame may be controlled by the vehicle onboard LiDAR system 210, the vehicle perception and planning system 220, a vehicle onboard computer, a cloud-based computer, or a combination thereof. ROIs are implemented by a LiDAR scanner. After the current set of ROIs is configured, one or more of the LiDAR system (e.g., system 210), a vehicle perception and planning system (e.g., system 220), a vehicle onboard computer, or a cloud-based computer may determine the next set of ROIs to be scanned in the next frame. While the below description using the LiDAR system for illustrating a process of determining the next set of ROIs, it is understood that similar process can be implemented using other systems or computers.

FIG. 8 illustrates a flow diagram of a method for determining the next set of ROIs according to one embodiment. In some embodiments, method 800 may be performed by the vehicle perception and planning system 220, the vehicle onboard LiDAR system 210, or a LiDAR perception sub-system in the vehicle onboard LiDAR system 210 (hereinafter collectively referred to as the “vehicle perception sub-system”). In some embodiments, method 800 may be performed by, a LiDAR system, a vehicle’s perception system, or a vehicle’s planning system, etc. Method 800 may also be performed by a combination of the systems described above. For example, certain steps in method 800 may be performed by the vehicle perception and planning system 220, and certain steps may be performed by a LiDAR system (e.g., system 210). Method 800 includes steps 810 to steps 870.

At step 810, a LiDAR system and/or a vehicle perception sub-system obtains sensor data provided by a LiDAR system. The LiDAR system may itself obtain the sensor data. Sensor data can be image data or 3D point cloud data representing the external environment perceived by the LiDAR system. Sensor data is generated by the LiDAR system at the end of each scan of the field-of-view (FOV), or during the scanning of the FOV. For example, for a LiDAR system having a front-facing LiDAR scanner, the sensor data pertains to a 3D point cloud data of the front view of the vehicle.

Sensor data may also be generated based on signals or information provided by other vehicle onboard sensors, such as cameras, radar sensors, ultrasonic sensors, infrared sensors, night vision sensors, inertial measurement unit (IMU) sensors, temperature sensors, speed sensors, wind sensors, or any other applicable sensors of the vehicle. In some examples, sensor data may be provided by a sensor fusion sub-system (e.g., sub-system 222 shown in FIG. 2). In some examples, sensor data may be provided by other vehicles, or by transportation infrastructure systems.

In some embodiments, sensor data can represent a continuous flow of image or point cloud data generated by the data source. If the data source is a LiDAR system, a new set of sensor data is generated after each scan of the FOV. If the data source is a camera or video camera, a new set of sensor data is generated after each frame is captured.

At step 820, the LiDAR system and/or the vehicle perception sub-system obtains one or more predefined perception policies. Predefined perception policies can be stored on a non-transitory machine-readable medium in a LiDAR system or vehicle computer. A perception policy defines how a LiDAR system responds to a given perception. In particular, a perception policy defines, for a given perception, whether regions of interest (ROIs) are needed in the field-of-view (FOV) and if so, how the ROIs should be configured in the FOV. The configuration of the ROI includes, for example, the number of ROIs, the position and size of each ROI, the resolution of each ROI, the shape of each ROI, and the time span each ROI may stay active, etc. For example, for the perception “driving on a level road”, the corresponding perception policy may define that one ROI is needed, the position of the ROI is right above the horizon line, the size of the ROI to be 5 degrees in the vertical FOV, and the time span to be staying on by default.

Predefined perception policies may include predefined perceptions and policies associated with the predefined perceptions. Predefined perceptions may include, a predefined vehicle-turning perception, a predefined vehicle uphill or downhill perception, a predefined road horizon perception, a predefined moving object perception, and a predefined possible obstacle perception. Policies associated with these predefined perceptions may be different. They may be customized based on past perception requirements and data, or dynamically adjusted.

At step 830, the LiDAR system and/or the vehicle perception sub-system derives one or more current perceptions based on the sensor data. A perception is a driving condition or road condition the vehicle is currently in or experiencing. The concept of perception alludes to what a human driver may feel or perceive when he or she is driving a vehicle. For example, when the vehicle is driving on a road with no slope, the perception may be “driving on a level road”. When the vehicle is stopped, the perception may be “vehicle stopped”. When pedestrians are crossing the road, the perception may be “pedestrian crossing”. When a ball is rolling on the road while the vehicle is driving, the perception may be “driving with a moving object”. Other perceptions may include, but are not limited to, “driving uphill”, “driving downhill”, “at a red light”, “turning left”, “turning right”, etc. Multiple perceptions may happen together at the same time. For example, a combination of perceptions may be “driving on a level road and turning left”, or “vehicle stopping at a red light and pedestrians crossing”, etc.

While a human driver derives perceptions based on his or her senses, a LiDAR system and/or a vehicle perception sub-system derives perceptions based on the sensor data. Referring back to FIG. 2, vehicle perception and planning system 220 may use the road detection subsystem 224 to identify objects and markings on the road. Localization and vehicle posture subsystem 225 may be used to determine the position of the vehicle and the vehicle’s posture. Vehicle perception and planning sub-system 220 may also use object classifier 223 to detect and classify objects and estimate the positions of the objects. After the objects are identified, obstacle predictor 226 may be used to predict their moving path or future positions. For example, based on multiple frames of sensor data, the LiDAR system and/or the vehicle perception sub-system may determine that surrounding objects are shifting counterclockwise, thereby deriving that the vehicle’s current perception is “vehicle turning right”. Perceptions may also be derived from other vehicle onboard sensors. For example, based on sensor data from the IMU, the LiDAR system and/or the vehicle perception sub-system may derive that the current perception is “driving on a level road”. For another example, the LiDAR system and/or the vehicle perception sub-system may derive from the 3D point cloud data to identify where the horizon is. Based on the position of the horizon, the LiDAR system and/or the vehicle perception sub-system (e.g., a part of system 220) may derive whether the vehicle is currently driving on a slope or a level road.

With reference still to FIG. 8, at step 840, the LiDAR system and/or the vehicle perception sub-system determines one or more policy-based ROI candidates based on the one or more predefined perception policies that correlate with the one or more current perceptions. ROI candidates may be provided by the LiDAR system, the vehicle perception and planning subsystem, which comprises a vehicle-embedded system, a distributed system or both. The vehicle perception and planning system may also include one or more computing devices external to the vehicle.

ROI candidates includes policy-based ROI candidates, and may also include request-based ROI candidates. Policy-based ROI candidates are ROI candidates determined based on predefined perception policies. Request-based ROI candidates are ROI candidates determined based on ROI reconfiguration requests (discussed in more detail later).

Current ROIs are the ROIs the LiDAR system has decided to implement in the current scan. ROI candidates, as compared to the current ROIs, are candidates that the LiDAR system plans to, but may not necessarily, implement as the ROIs in the next one or more scans. Whether an ROI candidate may mature into a next ROI to be implemented depends on determinations made by various systems including, e.g., the LiDAR system and/or the vehicle perception subsystem discussed herein. Input requests of ROI candidates may come from the LiDAR system itself, the vehicle computers, other vehicles or intelligent infrastructure systems, etc. An ROI candidate may or may not be eventually scanned by the LiDAR system. The decision of whether or not to scan an ROI candidate is made based on many factors, including, but not limited to, the current ROIs, the ROI candidate being considered, other ROI candidates, and priorities associated with each current ROI and ROI candidate.

Policy-based ROI candidates may be determined based on the predefined perception policies obtained by the LiDAR system and/or the vehicle perception sub-system. When making the determination, the LiDAR system and/or the vehicle perception sub-system may correlate the current perceptions, which were derived based on sensor data, with the predefined perceptions. Since each perception is associated with a perception policy, the LiDAR system and/or the vehicle perception sub-system may determine the policy-based ROI candidates based on the perception policy. For example, if the current perception is “driving on a level road”, the LiDAR system and/or the vehicle perception sub-system may determine the policy-based ROI candidates based on a predefined perception policy that correlates to the “driving on a level road” perception. The correlation may not be an exact match. For example, if the current perception is “driving on a bumpy road”, the LiDAR system and/or the vehicle perception sub-system may still correlate it with the predefined “driving on a level road” policy, if it is determined that the road is in general a level road (although each individual bump may be associated with an uphill and a downhill slope).

Each policy-based ROI candidate may comprise one or more of the following: a position of each candidate, a priority associated with each candidate; and one or more scan parameters associated with each candidate. The position of each candidate depicts the exact location of the ROI within the field of view. It may be expressed as the X,Y coordination of the four corners of the ROI, expressed as the start and end points in the horizontal FOV, or start and end angles of the vertical FOV. The priority of each policy-based ROI candidate is referred as “policy priority” herein to distinguish from the priorities of other types of ROI candidates described in this disclosure. For example, a “requested priority” is associated with the priority of a request-based ROI candidate (discussed in more detail later); a “scan priority” is associated with the priority of an ROI scan candidate (discussed in more detail later). Scan parameters are the parameters associated with the ROI candidate, which may include mirror speed or pulse duration associated with the ROI, and resolution associated with the ROI, etc.

At step 850, the LiDAR system and/or the vehicle perception sub-system determines whether an ROI reconfiguration request is provided. The ROI reconfiguration request can be provided based on, for example, a vehicle perception decision.

A vehicle perception decision may be rendered based on sensor data provided by the LiDAR scanner. A vehicle perception decision may also be rendered based on additional sensor data generated from additional vehicle onboard sensors of the vehicle, additional vehicles or transportation infrastructure systems. In some examples, the vehicle perception decision may be rendered based on sensor data of one or more objects provided by a camera, an ultrasonic sensor, or a radar.

In some examples, vehicle perception decision may be rendered based on geographical location data associated with the vehicle, such as inputs from the vehicle’s Global Positioning System (GPS), Global Navigation Satellite System (GNSS), or HD map, etc. For example, GPS location information may indicate that the vehicle is approaching a busy shopping mall. Since there might be more pedestrians walking around a shopping mall, more ROI candidates directing to the sidewalks may be requested in an ROI reconfiguration request. For another example, GPS location information may indicate that the vehicle is driving on a highway instead of on a city road. When the vehicle is driving on a highway, ROI candidates directing to both sides of the highway may not be needed. For another example, information from HD map may indicate that the vehicle is driving on the right-most vehicle lane, and is next to a bike line. Based on this information, more ROI candidates pointing to the bike lane may be requested to find out if there are cyclists riding on the bike lane.

In some examples, vehicle perception decision may be rendered based on vehicle posture data indicating which direction the vehicle is facing, or whether the vehicle is turning, or driving on uphill or downhill, etc. For example, if information from the vehicle posture data indicates that the vehicle is turning right at an intersection, more ROI candidates pointing to the crosswalk may be requested to find out if there are pedestrians crossing the street.

In some examples, vehicle perception decision may be rendered based on sensor data provided by roadside sensors or road intersection devices. As part of intelligent infrastructure systems, roadside sensors and/or road intersection devices may be implemented on the road to send real time traffic information to drive-by vehicles. For example, when a vehicle is trying to make a left turn at an intersection, the vehicle may proceed to turning left only when there is no oncoming traffic in the opposite traffic direction and when there is no pedestrians crossing the street to the left. Accordingly, the LiDAR system and/or the vehicle perception sub-system may request to configure one large ROI to scan further away in the front of the vehicle to monitor any oncoming traffic, and configure another large ROI to scan any close-by pedestrians to the left of the FOV. However, it might be the case that due to the limitation of the LiDAR system’s capacity, only one of the two ROI candidates can be implemented in the next frames. In this situation, if road intersection devices are installed in the intersection, the vehicle may obtain the oncoming traffic information from road intersection devices, and only need to request one ROI candidate pointing to the left of the FOV to scan any pedestrians crossing the street. In another embodiment, the LiDAR system may decide to implement both of the two ROI candidates but at different times or frames. For instance, the LiDAR system may implement one ROI candidate at a first frame, and then shift to implement the other ROI candidate at another frame.

In some examples, vehicle perception decision may be rendered based on sensor data provided by parking structure sensors. In some examples, real time traffic information may be provided by other vehicles on the road. For instance, sensors implemented in parking structures may inform the vehicle of the location of an empty parking spot. Upon receiving such information, the vehicle may request to configure more ROIs towards persons or objects that may be moving inside the parking structure, instead of using the ROIs to find empty parking spots.

In some examples, vehicle perception decision is rendered based on sensor data indicating current or future weather conditions. For example, if based on the weather information there will be foggy weather one mile away, more ROIs may be directed to potential positions of traffic lights to identify any changes in traffic signals.

An ROI reconfiguration request may comprise one or more request-based ROI candidates (discussed in more detail later). An ROI reconfiguration request may also comprise either priority data or vehicle perception data associated with the ROI candidates, or both. An ROI reconfiguration request may be generated by the vehicle perception sub-system, a LiDAR system, or a vehicle’s planning system, etc. The request may be generated when the configuration of ROIs needs to be changed so that the LiDAR system may implement other regions of interest in the FOV of the next frame. In some examples, an ROI reconfiguration request is provided based on a user-requested task. When the request is received by the LiDAR system and/or the vehicle perception sub-system, the LiDAR system and/or the vehicle perception sub-system may determine that an ROI reconfiguration request is provided. If such a request has not been received, in some examples, the LiDAR system and/or the vehicle perception sub-system may determine the next set of ROIs of the LiDAR scanner to be the current set of ROIs. That is, there is no change of the ROIs.

A change in ROI configuration may be needed when there is a change in perception. Based on real time sensor data, the LiDAR system and/or the vehicle perception sub-system may decide that the vehicle’s current perception has changed. For example, when the vehicle starts to drive from a level road to an uphill road, it may decide that the vehicle’s current perception has changed from “driving on a level road” to “driving uphill”. Based on this decision, the LiDAR system and/or the vehicle perception sub-system may generate an ROI reconfiguration request to move the existing ROIs up vertically so that the LiDAR can focus on the regions further down the road.

A change in ROI may also be needed to monitor a moving object. When a moving object, for example, an animal, a rolling ball, a car, or a person, etc., is detected in the field of view by the LiDAR system and/or the vehicle perception sub-system, the object may need to be monitored so that its next move or trajectory can be predicted. In some examples, the ROI reconfiguration request may come from the vehicle’s computer. For instance, when the vehicle’s computer detects a small moving object from the camera’s image, the computer may not be able to determine based on the 2D image whether the object is a small object close by, or a large object further away. The vehicle computer may decide to send a request to the LiDAR system to reconfigure the ROI to scan the moving object in higher resolution. From the 3D point cloud data generated by the LiDAR system, the vehicle computer may be able to confirm the distance of the object, the shape of the object, and its 3D position in relation to the surrounding environment. With this additional information from the LiDAR system, the vehicle computer may make a faster and more accurate decision regarding the object.

In some examples, the ROI reconfiguration request may be provided based on a confidence parameter, a level of importance threshold value, a completeness parameter associated, or a level of urgency threshold value. All of the above can be associated with a vehicle perception decision. Confidence parameter is associated with objects detected by the LiDAR system, the vehicle perception subsystem, and/or vehicle computer based on sensor data or image data. When the object is being identified using algorithms such as machine learning, deep learning, or artificial intelligence, etc., the object may be assigned a confidence score. For example, further away objects may have less confidence score because there is not enough data to identify the object. In this case, the ROI reconfiguration request may be generated so that the LiDAR system may be directed to scan an ROI including the object, thereby providing with more confidence for identification of the object. The LiDAR system and/or the vehicle perception subsystem may use a 3D object classification algorithm to identify the object is based on 3D point cloud data.

At step 860, in accordance with an ROI reconfiguration request being provided, the LiDAR system and/or the vehicle perception sub-system determines one or more request-based ROI candidates based on the ROI reconfiguration request.

Similar to the policy-based ROI candidate, each request-based ROI candidate also comprise one or more of the following: a position of each candidate, a priority associated with each candidate; and one or more scan parameters associated with each candidate. The priority of each request-based ROI candidate is referred as “requested priority” herein to distinguish from the priorities of other types of ROI candidates discussed in this disclosure. For example, a “policy priority” is associated with the priority of a policy-based ROI candidate.

The “priority” of an ROI candidate relates to the importance of that ROI candidate compared to other ROI candidates. The higher the priority, the higher the possibility the ROI candidate will be scanned by the LiDAR system in the next frame. Because a vehicle may be driving in a dynamic driving condition, for example, on a busy road with multiple moving objects, multiple new ROI requests may come from multiple components of the system at the same time. Some ROI requests may be more important than others. For example, while the vehicle is driving, the LiDAR system may discover that a person-like object 20 meters away is moving from the side of the road towards the center of the road, indicating that a person may be crossing the street. A new ROI candidate is then requested by the LiDAR system to scan the person-like object with higher resolution in the next scan. At the same time, the vehicle computer may discover from the camera image that a vehicle-like object is crossing the street at an intersection 100 meters away. A different ROI candidate is then requested by the vehicle computer, hoping that the vehicle-like object may be scanned by the LiDAR system in the next scan. Apparently, the former ROI request is more important than the latter one because the moving object might be a person and is closer to the vehicle, thus, the former ROI request should have a higher priority than the latter request.

Priority of ROI candidates may be in any range. For example, the priority may be on a scale of 1 to 10, where 10 represents the highest priority. The priority of different types of ROI candidates may have a common scale. For example, the policy priority of policy-based ROI candidates, the requested priority of request-based ROI candidates, and the scan priority of ROI scan candidates (discussed in more detail later) may all have the same scale of 1 to 10. In other examples, the different ROI candidates may have a different scale. In some embodiments, the priorities of policy-based ROI candidates, request-based ROI candidates, and scan candidates are mixed and ranked together.

Priority of an ROI candidate may be selected depending on many factors, which may include, but are not limited to, speed of the vehicle, classification of the object associated with the ROI candidate, brightness of the environment (e.g., whether it’s bright or dark outside), location of the vehicle, time of the day, and accident history of a particular section of the road, etc. For example, if the vehicle is travelling at a slow speed, objects faraway may have a lower priority. If the vehicle is travelling at a high speed, objects close-by may have a higher priority. In some examples, objects classified as human may have higher priority. Sometimes, the same type of objects may have different priorities depending on the location of the vehicle, and the time of the day, etc. For example, a person-like object may have a higher priority if the location is near a senior care facility (indicating that the person may be a senior who may be less aware of the surrounding traffic). On the other hand, the same person-like object may have a slightly lower priority if the vehicle is driving on a college campus (indicating that the person may likely be a college student). If the vehicle is driving near an elementary school and the time is when the school is over, any person-like object may have a higher priority. For another example, if based on historical data the vehicle is approaching an intersection where multiple fatal accidents happened recently, any person-like or vehicle-like object may have a higher priority.

If the ROI reconfiguration request is provided, the LiDAR system and/or vehicle perception sub-system determines the details of the request-based ROI candidates, including the position, the priority and scan parameters of each candidate based on the ROI reconfiguration request.

At step 870, the LiDAR system and/or the vehicle perception sub-system determines the next set of ROIs for the LiDAR scanner to scan based on the current set of ROIs, and one or both of the policy-based ROI candidates and the request-based ROI candidates. The LiDAR system and/or the vehicle perception sub-system decides the next set of ROIs to be scanned by balancing all the available ROI candidates received from the LiDAR system, the vehicle computer, or other sources. The decision may be made by sorting the priority associated with each ROI candidate and picking the candidate having the highest priority. If there are multiple ROI candidates having the same highest priority, the LiDAR system and/or the vehicle perception sub-system may decide if all the highest priority ROI candidates may fit into one FOV. In some examples, the decision is made based on a calculation of the total number of points of the entire FOV, assuming all the highest priority ROI candidates are included. If the total number of points of the entire FOV exceeds the LiDAR system’s maximum capacity, the LiDAR system and/or the vehicle perception sub-system may include only some ROI candidates in the next frame, and leave the remaining candidates to be scanned in the frames thereafter. The LiDAR system and/or the vehicle perception sub-system may also decide the next set of ROIs based on other factors, such as the size of the ROI candidates, the relative positions of each candidate, or scan parameters of each ROI candidate, etc. In some examples, an ROI scan list may be used to decide the next ROI scan candidates.

FIG. 9 illustrates a flow diagram of a method of using an ROI scan list for determining the next set of ROIs according to one embodiment. In some embodiments, method 900 may be performed by a LiDAR system and/or a vehicle perception sub-system. In some embodiments, method 900 may be performed by the vehicle onboard LiDAR system, a LiDAR system, a vehicle’s perception system, or a vehicle’s planning system, etc. Method 900 includes steps 910 to steps 930.

At step 910, the LiDAR system and/or the vehicle perception sub-system determines one or more ROI scan candidates based on one or both of the one or more policy-based ROI candidates and the one or more request-based ROI candidates. An ROI scan candidate is another type of ROI candidate. Similar to the other two ROI candidates, ROI scan candidate may comprise one or more of the following: a position of each ROI scan candidate; a scan priority associated with each candidate; and one or more scan parameters associated with each candidate. Unlike policy-based and request-based ROI candidates, which are interim versions of ROI candidates representing inputs from various sources, an ROI scan candidate is used to represent ROI candidates in the final version ready to be implemented by a LiDAR scanner and be scanned in the next frame. ROI scan candidates are determined from either policy-based ROI candidates, or request-based ROI candidates, or both.

When determining the components of the ROI scan candidates, the LiDAR system and/or the vehicle perception sub-system may use the same information from the components of the other two ROI candidates. In some examples, the LiDAR system and/or the vehicle perception sub-system may modify the components of the other two ROI candidates. For example, if there is a significant overlap in position between two policy-based ROI candidates, or between a policy-based ROI candidate and a request-based ROI candidate, the LiDAR system and/or the vehicle perception sub-system may, based on the capacity of the LiDAR system in that frame, determine the ROI scan candidate to cover the areas of both ROI candidates, and update the positions of the ROI scan candidate to cover the areas of both ROI candidates. In this way, only one ROI will be scanned in the next frame instead of two overlapping ROIs in two frames.

In some examples, determining the ROI scan candidates involves determining the scan priority of each ROI scan candidate. The determination of scan priority is made by balancing and comparing the priorities of current ROI and other ROI candidates. For example, the determination may be made based on scan priorities associated with the current set of ROIs, the policy priority associated with policy-based ROI candidates, the requested priority associated with the request-based ROI candidates, and one or more priority determination rules. In some examples, priority determination rules may comprise certain arbitration rules to resolve the conflict when ROI candidates from multiple sources may have the same priority. In some examples, scan priority of ROI scan candidates may be determined by weight-based algorithms.

At step 920, the LiDAR system and/or the vehicle perception sub-system updates the one or more ROI scan candidates into an ROI scan list. An ROI scan list is a table having one or more rows, with each row representing one ROI scan candidate. After the update, the ROI scan list contains all the ROI scan candidates available to be scanned by the LiDAR system in the next frame or frames.

At step 930, the LiDAR system and/or the vehicle perception sub-system configures the LiDAR scanner to scan the next set of ROIs, the next set of ROIs being the one or more ROI scan candidates in the ROI scan list having a highest scan priority. In some examples, after the highest priority ROI scan candidates have been scanned, the candidates will be deleted from the ROI scan list so that the ROI scan candidates having the next highest scan priority will be configured in the next scan. In some examples, certain ROI candidates may always remain in the ROI scan list, such as, the ROI candidates associated with the perception “driving on a level road.” This could be useful in implementing default ROI implementations for predefined perceptions. In some examples, the scan priority of the default ROI candidates may remain unchanged. When ROI requests with higher priority ROI candidates are received, the LiDAR system and/or the vehicle perception sub-system will scan the higher priority ROIs. After the higher priority ROIs are scanned, the LiDAR system and/or the vehicle perception sub-system will fall back to the default ROI scan option.

The techniques disclosed herein can be used to dynamically configure ROIs in each LiDAR scan based on different needs. For example, the LiDAR system may be configured, though constantly updating the ROI scan list, so that a fixed size of ROI is being scanned repeatedly in a horizontal or vertical direction. In some examples, this ROI scan pattern may be implemented as a default option. The benefit of this ROI scan pattern is that the entire FOV is being scanned in higher resolution over a certain period of time. When certain objects are discovered in the ROI, the LiDAR system and/or the vehicle perception sub-system may configure more ROIs towards that object to identify that object and/or predict the next movement of that object.

In some examples, ROIs may be reversely generated. That is, non-ROIs in the last frame become the ROIs in the next frame. In some examples, ROIs can be formatted by software filtering and truncation. Point cloud data from the LiDAR system may be averaged and compressed before the data is provided to the vehicle computer. In some situations, certain regions of the point cloud data are provided without compression. From the perspective of the vehicle computer, the regions of point cloud data without compression become the ROIs of that point cloud.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A LiDAR scanning system having reconfigurable regions-of-interest (ROIs), comprising:
a LiDAR scanner configured to scan a current set of regions-of-interest (ROIs) within a field-of-view (FOV); and
a LiDAR perception sub-system coupled to the LiDAR scanner, the LIDAR perception sub-system including one or more processors, a memory device, and processor-executable instructions stored in the memory device, the processor-executable instructions comprising instructions for:
obtaining sensor data provided at least by the LiDAR scanner;
obtaining one or more predefined perception policies;
determining whether an ROI reconfiguration request is provided, the ROI reconfiguration request being provided based on a vehicle perception decision;
in accordance with an ROI reconfiguration request being provided, determining a next set of ROIs for the LiDAR scanner to scan based on a current set of ROIs, and the one or more predefined perception policies, and the ROI reconfiguration request.

2. The system of claim 1, wherein the one or more predefined perception policies comprise one or more predefined perceptions and one or more policies associated with the one or more predefined perceptions.

3. The system of claim 2, wherein the one or more predefined perceptions comprise one or more of:
a predefined vehicle-turning perception;
a predefined vehicle uphill or downhill perception;
a predefined road horizon perception;
a predefined moving object perception; and
a predefined possible obstacle perception.

4. The system of claim 2, wherein determining the next set of ROIs comprises determining one or more policy-based ROI candidates based on the sensor data and the one or more predefined perception policies by:
deriving one or more current perceptions based on the sensor data;
correlating the one or more current perceptions with the one or more predefined perceptions of the one or more predefined perception policies; and
determining one or more policy-based ROI candidates based on the one or more policies associated with the one or more predefined perceptions.

5. The system of claim 4, wherein each of the one or more policy-based ROI candidates comprises one or more of:
a position of each of the policy-based ROI candidate;
a policy priority associated with each of the policy-based ROI candidate; and
one or more scan parameters associated with each of the policy-based ROI candidate.

6. The system of claim 5, wherein determining the next set of ROIs comprises determining one or more request-based ROI candidates based on the ROI reconfiguration request, each of the one or more request-based ROI candidates comprises one or more of:
a position of each of the request-based ROI candidate;
a requested priority associated with each of the request-based ROI candidate; and
one or more scan parameters associated with each of the request-based ROI candidate.

7. The system of claim 6, wherein determining the next set of ROIs for the LiDAR scanner to scan based on the current set of ROIs, and one or both of the one or more policy-based ROI candidates and the one or more request-based ROI candidates comprises:
determining one or more ROI scan candidates based on one or both of the one or more policy-based ROI candidates and the one or more request-based ROI candidates, wherein each of the one or more ROI scan candidates comprises one or more of:
a position of each of the one or more ROI scan candidates;
a scan priority associated with each of the one or more ROI scan candidates; and
one or more scan parameters associated with each of the one or more ROI scan candidates;
updating the one or more ROI scan candidates into an ROI scan list, the ROI scan list comprising the one or more ROI scan candidates;
configuring the LiDAR scanner to scan the next set of ROIs, the next set of ROIs being the one or more ROI scan candidates in the ROI scan list having a highest scan priority.

8. The system of claim 7, wherein determining one or more ROI scan candidates based on one or both of the one or more policy-based ROI candidates and the one or more request-based ROI candidates comprises determining the scan priority of each of the one or more ROI scan candidates based on one or more of:
one or more scan priorities associated with the current set of ROIs,
the policy priority associated with each of the one or more policy-based ROI candidates,
the requested priority associated with each of the one or more request-based ROI candidates, and
priority determination rules.

9. The system of claim 1, wherein the processor-executable instructions comprise further instructions for obtaining additional sensor data from at least one of:
one or more additional vehicle onboard sensors of the vehicle;
one or more additional vehicles; and
one or more transportation infrastructure systems.

10. The system of claim 9, wherein the vehicle perception decision is rendered based on one or more of:
the sensor data provided at least by the LiDAR scanner; and
the additional sensor data.

11. The system of claim 1, wherein the ROI reconfiguration request comprises:
one or more ROI candidates for the next set of ROIs of the LiDAR scanner; and
at least one of priority data or vehicle perception data associated with the one or more ROI candidates.

12. The system of claim 1, wherein one or both of the policy-based ROI candidates and the one or more request-based ROI candidates are provided by at least one of:
the LiDAR perception sub-system; and
a vehicle perception and planning system, wherein the vehicle perception and planning system comprises at least one of a vehicle-embedded system or a distributed system including one or more computing devices external to a vehicle including elements of the vehicle perception and planning system.

13. The system of claim 1, wherein the LiDAR scanning system is integrated in or mounted to a vehicle.

14. The system of claim 13, wherein the vehicle perception decision is rendered based on sensor data of one or more objects provided by at least one of a camera, an ultrasonic sensor, or a radar; and wherein the ROI reconfiguration request is provided based on one or more of:
a confidence parameter associated with the vehicle perception decision;
a level of importance threshold value associated with the vehicle perception decision;
a completeness parameter associated with the vehicle perception decision; and
a level of urgency threshold value associated with the vehicle perception decision.

15. The system of claim 13, wherein the vehicle perception decision is rendered based on at least one of geographical location data associated with the vehicle or vehicle posture data.

16. The system of claim 13, wherein the vehicle perception decision is rendered based on sensor data provided by at least one of roadside sensors, parking structure sensors, road intersection devices, or sensors from one or more additional vehicles.

17. The system of claim 13, wherein the vehicle perception decision is rendered based on sensor data indicating at least one of current weather conditions or future weather conditions.

18. The system of claim 13, wherein the ROI reconfiguration request is provided based on a user-requested task.

19. The system of claim 1, wherein the processor-executable instructions comprise further instructions for:
in accordance with a ROI reconfiguration request not being received, determining the next set of ROIs of the LiDAR scanner to be the current set of ROIs.

20. A system configured for providing regions-of-interest (ROIs) reconfiguration, comprising:
a vehicle perception and planning system including one or more processors, a memory device, and processor-executable instructions stored in the memory device, the processor-executable instructions comprising instructions for:
obtaining a current set of ROIs used by a LiDAR scanner;
obtaining one or more predefined perception policies;
determining whether an ROI reconfiguration request is provided, the ROI reconfiguration request being provided based on a vehicle perception decision;
in accordance with an ROI reconfiguration request being provided, determining a next set of ROIs for the LiDAR scanner to scan based on the one or more predefined perception policies and the ROI reconfiguration request;.

21. A method for reconfiguring one or more regions-of-interest (ROIs) of a light detection and ranging (LiDAR) scanner, the method being performed by one or more processors and memory, the method comprising:
obtaining sensor data provided at least by the LiDAR scanner;
obtaining one or more predefined perception policies;
determining whether an ROI reconfiguration request is provided, the ROI reconfiguration request being provided based on a vehicle perception decision;
in accordance with an ROI reconfiguration request being provided, determining a next set of ROIs for the LiDAR scanner to scan based on a current set of ROIs, and the one or more predefined perception policies, and the ROI reconfiguration request.

22. The method of claim 21, wherein the one or more predefined perception policies comprise one or more predefined perceptions and one or more policies associated with the one or more predefined perceptions.

23. The method of claim 22, wherein determining the next set of ROIs comprises determining one or more policy-based ROI candidates based on the sensor data and the one or more predefined perception policies by:
deriving one or more current perceptions based on the sensor data,
correlating the one or more current perceptions with the one or more predefined perceptions of the one or more predefined perception policies; and
determining one or more policy-based ROI candidates based on the one or more policies associated with the one or more predefined perceptions.

24. The method of claim 23, wherein each of the one or more policy-based ROI candidates comprises one or more of:
a position of each of the policy-based ROI candidate;
a policy priority associated with each of the policy-based ROI candidate; and
one or more scan parameters associated with each of the policy-based ROI candidate.

25. The method of claim 24, wherein determining the next set of ROIs comprises determining one or more request-based ROI candidates based on the ROI reconfiguration request, each of the one or more request-based ROI candidates comprises one or more of:
a position of each of the request-based ROI candidate;
a requested priority associated with each of the request-based ROI candidate; and
one or more scan parameters associated with each of the request-based ROI candidate.

26. The method of claim 25, wherein determining the next set of ROIs for the LiDAR scanner to scan based on the current set of ROIs, and one or both of the one or more policy-based ROI candidates and the one or more request-based ROI candidates comprises:
determining one or more ROI scan candidates based on one or both of the one or more policy-based ROI candidates and the one or more request-based ROI candidates, wherein each of the one or more ROI scan candidates comprises one or more of:
a position of each of the one or more ROI scan candidates;
a scan priority associated with each of the one or more ROI scan candidates; and
one or more scan parameters associated with each of the one or more ROI scan candidates;
updating the one or more ROI scan candidates into an ROI scan list, the ROI scan list comprising the one or more ROI scan candidates;
configuring the LiDAR scanner to scan the next set of ROIs, the next set of ROIs being the one or more ROI scan candidates in the ROI scan list having a highest scan priority.

27. The method of claim 26, wherein determining one or more ROI scan candidates based on one or both of the one or more policy-based ROI candidates and the one or more request-based ROI candidates comprises determining the scan priority of each of the one or more ROI scan candidates based on one or more of:
one or more scan priorities associated with the current set of ROIs,
the policy priority associated with each of the one or more policy-based ROI candidates,
the requested priority associated with each of the one or more request-based ROI candidates, and
priority determination rules.

28. A non-transitory computer readable medium storing one or more programs, the one or more programs comprising instructions, which when executed by one or more processors of an electronic device, cause the electronic device to:
obtain sensor data provided at least by the LiDAR scanner;
obtain one or more predefined perception policies;
determine whether an ROI reconfiguration request is provided, the ROI reconfiguration request being provided based on a vehicle perception decision;
in accordance with an ROI reconfiguration request being provided, determine a next set of ROIs for the LiDAR scanner to scan based on a current set of ROIs, and the one or more predefined policies, and the ROI reconfiguration request.
